(19) United States
(12) Patent Application Publication
(10) Pub. No.: US 2021/0223022 A1
(43) Pub. Date: Jul. 22, 2021

(54) SYSTEM AND METHOD

(71) Applicant: KABUSHIKI KAISHA TOSHIBA, Tokyo (JP)

(72) Inventors: Hidenori OKUNI, Yokohama Kanagawa (JP); Kentaro YOSHIOKA, Kawasaki Kanagawa (JP); Tuan Thanh TA, Kawasaki Kanagawa (JP)

(73) Assignee: KABUSHIKI KAISHA TOSHIBA, Tokyo (JP)

(21) Appl. No.: 17/014,188

(22) Filed: Sep. 8, 2020

(30) Foreign Application Priority Data
Jan. 16, 2020 (JP) 2020-005111

(51) Int. Cl. G01B 7/14; G01B 11/22; G01B 11/03

(52) U.S. Cl. CPC G01B 7/14; G01B 11/03; G01B 11/22

(57) ABSTRACT

A method using an electronic apparatus capable of measuring a distance from the electronic apparatus, acquires information on at least one of a position or shape of an object in accordance with a reflected light reflected by both the object and a reflector. The reflector is disposed substantially parallel to one of a first plane, a second plane, and a third plane that defines a coordinate system of the electronic apparatus to measure the distance.

### CROSS REFERENCE TO RELATED APPLICATIONS

This application is based upon and claims the benefit of priority from the prior Japanese Patent Application No. 2020-5111, filed on Jan. 16, 2020, the entire contents of which are incorporated herein by reference.

### FIELD

An embodiment of the present invention relates to a system and a method.

### BACKGROUND

Techniques have been proposed for generating a depth map according to the distance to an object. To generate a depth map, it is necessary to provide a function of emitting a laser light, receiving reflected laser light reflected by an object, and measuring the distance according to time from the emitting timing to the receiving timing.

Here, the laser light has a property of being reflected by a reflector such as a mirror. Therefore, when the laser beam for distance measurement is emitted to such a mirror, the emitted laser beam may be reflected by the mirror to travel toward the object, and received after reflected by the object and reflected again by the mirror. In this case, when a depth map is generated in accordance with the received laser light, a depth map including a virtual image as if the object were present at the back of the mirror is obtained. In reality, the object exists in front of the mirror, but it is not possible to determine whether the laser beam reflected by the object has been reflected by the mirror because the distance is measured by the optical path length of the laser beam in the distance measurement using a laser beam.

The virtual image visually recognized at the back of the mirror reflected in the depth map can be converted into a real image by numerical calculation if the position and angle of the mirror are known. Therefore, a technique for accurately calculating the position and angle of the mirror is required.

In particular, when the mirror is set at a predetermined location, it is necessary to perform a coordinate conversion for translation, a coordinate conversion for rotation, and a coordinate conversion from the virtual image to the real image to convert the virtual image reflected in the mirror into the real image. This results in a very large amount of computational processing.

### BRIEF DESCRIPTION OF THE DRAWINGS

FIG. 1 is a block diagram illustrating a schematic configuration of a system according to an embodiment;

FIG. 2 illustrates an example of measuring a distance to an object using a mirror;

FIG. 3A illustrates an example in which a mirror is disposed at a predetermined coordinate position;

FIG. 3B illustrates an example in which a mirror is moved by a conversion matrix Hp+;

FIG. 3C illustrates an example in which a mirror is moved by a conversion matrix Hp− and restored to the original coordinate system;

FIG. 4 is a flowchart illustrating a processing operation of the system according to the present embodiment; and

FIG. 5 illustrates an example in which the present embodiment is applied to a gating system.

### DETAILED DESCRIPTION

According to one embodiment, a method using an electronic apparatus capable of measuring a distance from the electronic apparatus, acquires information on at least one of a position or shape of an object in accordance with a reflected light reflected by both the object and a reflector. The reflector is disposed substantially parallel to one of a first plane, a second plane, and a third plane that defines a coordinate system of the electronic apparatus to measure the distance.

Embodiments of a system will be described below with reference to the accompanying drawings. Although the following description will focus on the major constituent components of the system, there may be constituent components and functions in the system described below that are not illustrated or described. The following description does not exclude any constituent components or functions not illustrated or described herein.

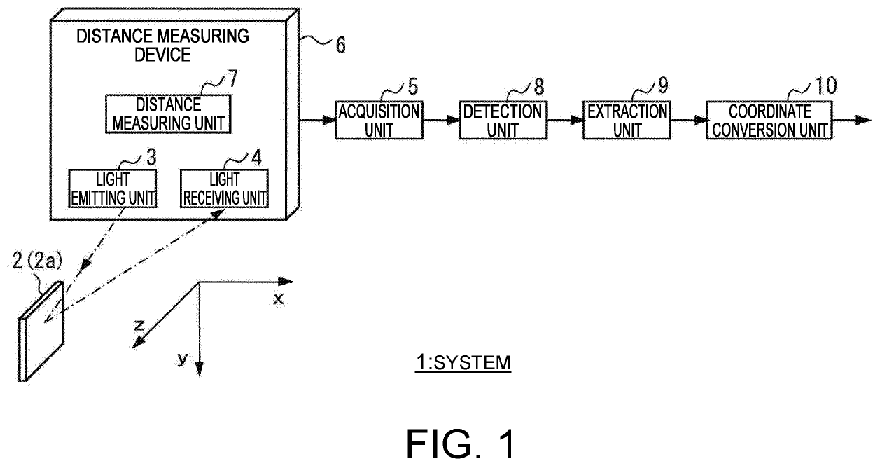

FIG. 1 is a block diagram illustrating a schematic configuration of a system 1 according to an embodiment. The system 1 of FIG. 1 has a function of optically detecting an image reflected on a reflector 2 such as a mirror 2a. The system 1 of FIG. 1 includes a light emitting unit 3, a light receiving unit 4, and an acquisition unit 5. Alternatively, the system 1 of FIG. 1 may include an acquisition unit 5, a detection unit 8, an extraction unit 9, and a coordinate conversion unit 10.

The light emitting unit 3 and the light receiving unit 4 are installed in, for example, a distance measuring device 6. The distance measuring device 6 measures a distance from the distance measuring device 6 to the object in accordance with a time difference between a light emitting timing at which the light is emitted from the light emitting unit 3 and a light receiving timing at which the light reflected by the object and received by the light receiving unit 4. As described above, the distance measuring device 6 is a light detection and ranging (LiDAR) device that measures the distance by a time of flight (ToF) method. Note that, as will be described later, the system 1 according to the present embodiment is also applicable to a case where information on at least one of the position or shape of a thing (also referred to as an object) is acquired using a stereo camera. Therefore, the light emitting unit 3 is not an essential component.

The light emitting unit 3 emits light having an optical axis center in a predetermined direction within a predetermined coordinate system. In the present embodiment, it is assumed that the reflector 2 is disposed substantially parallel to one of first, second, and third planes that define a predetermined coordinate system and are orthogonal to each other. Therefore, when the reflector 3 is disposed substantially parallel to any of the first, second, and third planes that are orthogonal to each other and define the predetermined coordinate system, the light emitting unit 3 emits light having the optical axis center in a predetermined direction in the coordinate system. Assuming that the three axes of the coordinate system described above are x, y, and z, the first to third planes spread in two axial directions of the xyz axes. For example, a first plane is the xy-plane, a second plane is the yz-plane, and a third plane is the zx plane.

Here, being substantially parallel is not necessarily limited to being completely parallel, but some non-parallelism is acceptable. As will be described later, in the present embodiment, a depth map is generated using the time until the light reflected by the reflector 2 is received by the light receiving unit 4, and a virtual image included in the depth map is converted into a real image by coordinate conversion processing. If the plane direction of the reflector 2 is not parallel to any of the first to third planes, the coordinate conversion processing partly includes coordinate rotation processing. However, if the reflector 2 is slightly non-parallel to any of the first to third planes, the conversion processing from the virtual image to the real image can be performed within an acceptable range even without the rotation processing. “Being slightly non-parallel” depends on how much accuracy is allowed, and may be a case where an angular error is ±10 degrees from a parallel direction, for example.

The light emitting unit 3 may include a plurality of light sources, each emitting light having a predetermined axis as the optical axis center. Alternatively, the light emitting unit 3 may have a predetermined direction as the optical axis center, and switch the light emitting direction of the light within a predetermined angular range. That is, the light emitting unit 3 may scan the light emitting direction within a predetermined angular range. Alternatively, the light emitting unit 3 may include a plurality of light sources, each emitting light in a different light emitting direction.

The light emitted by the light emitting unit 3 may be laser light with its frequency and phase being aligned. The light emitting unit 3 intermittently emits pulsed laser light at a predetermined cycle. An interval at which the light emitting section 3 emits the laser light is a time interval equal to or longer than the time required for the distance measuring device 6 to measure the distance for each pulse of the laser light.

The light receiving unit 4 receives light from at least a portion of the range in the three-dimensional space including the first to third planes. More specifically, the light receiving unit 4 includes, although not illustrated, a photodetector, an amplifier, a light receiving sensor, an analog-to-digital (A/D) converter, and the like. The photodetector receives part of emitted laser light and converts it into an electric signal. The amplifier amplifies the electric signal output from the photodetector. The light receiving sensor converts the received laser light into an electric signal. The A/D converter converts the electric signal output from the light receiving sensor into a digital signal.

The distance measuring device 6 includes a distance measuring unit 7 in addition to the light emitting unit 3 and the light receiving unit 4. The distance measuring unit 7 measures the distance to the point where the received electromagnetic wave is reflected in accordance with a time difference between a transmission timing of the transmitted electromagnetic wave and a reception timing of the received electromagnetic wave. When laser light is used as the electromagnetic wave, the distance measuring unit 7 measures the distance in accordance with Equation (1):

Distance=Speed of Light×(reception timing of reflected light−transmission timing of reflected light)/2 (1)

The distance measuring unit 7 measures the distance to various objects existing around the distance measuring device 6, and can generate a depth map in accordance with the measured distance to each object. The generated depth map is sent to the acquisition unit 5. The acquisition unit 5 disposes the reflector 2 substantially parallel to any one of the first, second, and third planes which are orthogonal to each other and define the coordinate system for measuring the distance of an electronic device 1. Then, in accordance with the incident light including the light reflected by an object and the reflector 2, the information on at least one of the position or shape of the object is acquired. That is, the information on at least one of the position or shape of the object is derived from the information obtained from the incident light in accordance with the fact that the reflector 2 is disposed substantially parallel to any of the first, second, and third planes. When the electronic device 1 includes the light emitting unit that emits light having a light emitting direction as the optical axis center in the coordinate system and the light receiving unit 4 that receives the incident light, the incident light at least includes the light received by the light receiving unit 4 after the light is emitted from the light emitting unit, reflected by the reflector 2, reflected by the object, and reflected by the reflector 2. In the example of the system of FIG. 1, the acquisition unit 5 acquires surrounding information in accordance with the light received by the light receiving unit 4. More specifically, the acquisition unit 5 uses the distance measuring device 6 to acquire surrounding information.

Note that FIG. 1 illustrates the example in which the acquisition unit 5 acquires the surrounding information using the distance measuring device 6, but the acquisition unit 5 may acquire the surrounding information in accordance with the depth map that is based on the distance measured by the distance measuring unit 7 to acquire the surrounding information, or may acquire the surrounding information using a device, a sensor, or the like other than the distance measuring device 6. For example, if a photographing unit that photographs the surroundings is provided as will be described later, the acquisition unit 5 may acquire the surrounding information in accordance with the image photographed by the photographing unit. The acquisition unit 5 acquires the surrounding information using the same coordinate system as the coordinate system of the light emitting unit 3 and the light receiving unit 4.

The surrounding information acquired by the acquisition unit 5 may include the depth map generated by the distance measuring unit 7. The surrounding information may include reflector information. The reflector information is information including at least one of the position, size, height, or angle of the reflector 2.

Here, the reflector 2 is intended to include various members that perform specular reflection (regular reflection) such as the mirror 2a, and any shape and size of the reflector 2 may be used. Any purpose may be used for installing the reflector 2. For example, the reflector 2 may be installed to reflect the blind spot area of the robot arm, to photograph the blind spot area of a security camera, or for other purposes. In addition, the reflector 2 may be placed at any location and may be placed outdoors or indoors.

In the system 1 according to the present embodiment, it is assumed that the reflector 2 is disposed substantially parallel to one of the first to third planes. However, in a case where a plurality of the reflectors 2 is provided, at least one of the reflectors 2 may be disposed substantially parallel to one of the first to third planes. As will be described later, disposing the reflector 2 substantially parallel to any one of the first to third planes can lead to a reduction of the amount of calculation processing in converting the virtual image reflected on the reflector 2 into the real image.

The detection unit 8 in the system 1 of FIG. 1 detects information including at least one of the position, size, height, or angle of the reflector 2 included in the surrounding information acquired by the acquisition unit 5. Information including at least one of the position, size, height, or angle of the reflector 2 may be held in advance.

The extraction unit 9 in the system 1 of FIG. 1 extracts information (virtual image) reflected on the reflector 2 in accordance with the surrounding information acquired by the acquisition unit 5 and the mirror information (reflector information) detected by the detection unit 8. The extraction unit 9 performs extraction by calculation processing in accordance with the surrounding information and the virtual image. If the position, size, height, and angle of the mirror 2a are known, the range of reflection in the mirror 2a can be extracted from the surrounding information by calculation processing.

The coordinate conversion unit 10 in the system 1 of FIG. 1 performs the coordinate conversion of the virtual image extracted by the extraction unit 9, and combines the information of the real image after the coordinate conversion with the surrounding information. This enables acquisition, via the reflector 2, of the information on the object existing in the blind spot that cannot be directly obtained by the acquisition unit 5, so that the blind spot can be reduced.

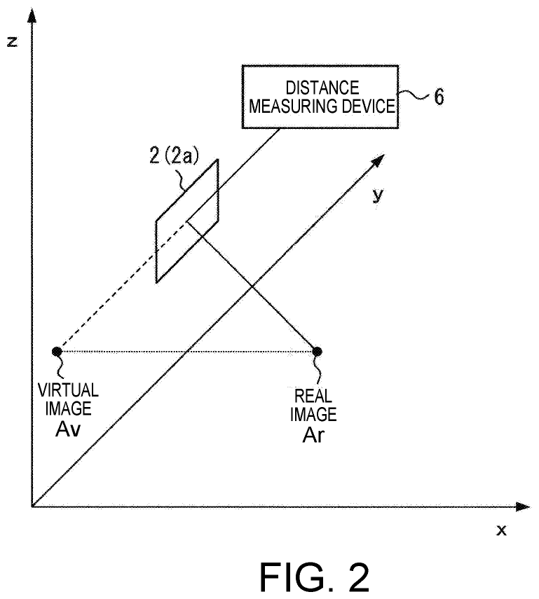

The coordinate converting processing performed by the coordinate conversion unit 10 is described in detail below. FIG. 2 illustrates an example of measuring the distance to the object using the plane mirror 2a (hereinafter, simply referred to as the mirror 2a) as the reflector 2. In FIG. 2, the coordinate system of the acquisition unit 5 is illustrated in xyz. In an example, it is assumed that the mirror 2a is installed in the yz-plane and an object exists at coordinates (−x0, y0, z0). The light emitted from the light emitting unit 3 and reflected by the reflector 2 is reflected by the object (real image), then by the mirror 2a, and received by the light receiving unit 4. The image reflected on the reflector 2 is a virtual image, and the position of the virtual image is at the coordinates (x0, y0, z0) (broken line in the drawing). Since the distance measuring unit 7 measures the distance in accordance with propagation time of light, and mistakenly recognizes that the object exists at the virtual image position. Therefore, it is necessary to perform reflection conversion on the coordinates of the virtual image into the coordinate system of the real image. When the reflector 2 is disposed on the yz-plane as illustrated in FIG. 2, only the inversion of the sign of the x-axis is necessary. The coordinates Av of the virtual image are represented by the matrix on the left side of Equation (2), and the reflection conversion matrix Hc in which the mirror 2a is disposed in the yz-plane is represented by the matrix on the right side of Equation (2). The two matrices Av and Hc of Equation (2) are expanded into four dimensions to express translation conversion which will be described later.

$${A}_{v} = ( \begin{matrix}{x}_{0} \\ {y}_{0} \\ {z}_{0} \\ 1\end{matrix} ) , {H}_{c} = ( \begin{matrix}- 1 & 0 & 0 & 0 \\ 0 & 1 & 0 & 0 \\ 0 & 0 & 1 & 0 \\ 0 & 0 & 0 & 1\end{matrix} ) \qquad ( 2 )$$

The conversion to coordinates of the real Ar is represented by the inner product of the reflection conversion matrix and the virtual image coordinates, as illustrated in Equation (3):

$${A}_{r} = {H}_{c} {A}_{v} = ( \begin{matrix}- {x}_{0} \\ {y}_{0} \\ {z}_{0} \\ 1\end{matrix} ) \qquad ( 3 )$$

As illustrated in Equation (3), when the reflector 2 is disposed in the yz-plane, only the inversion of the sign of the x-axis is necessary.

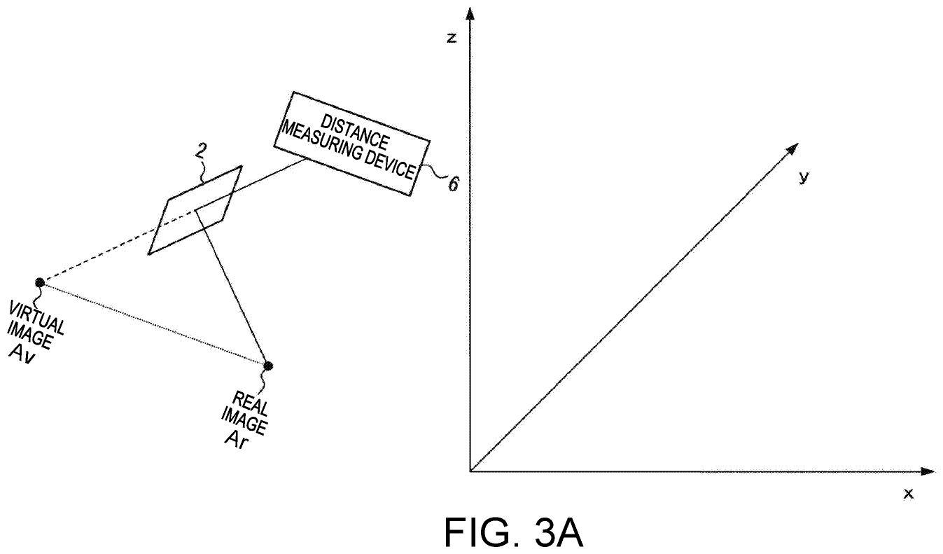

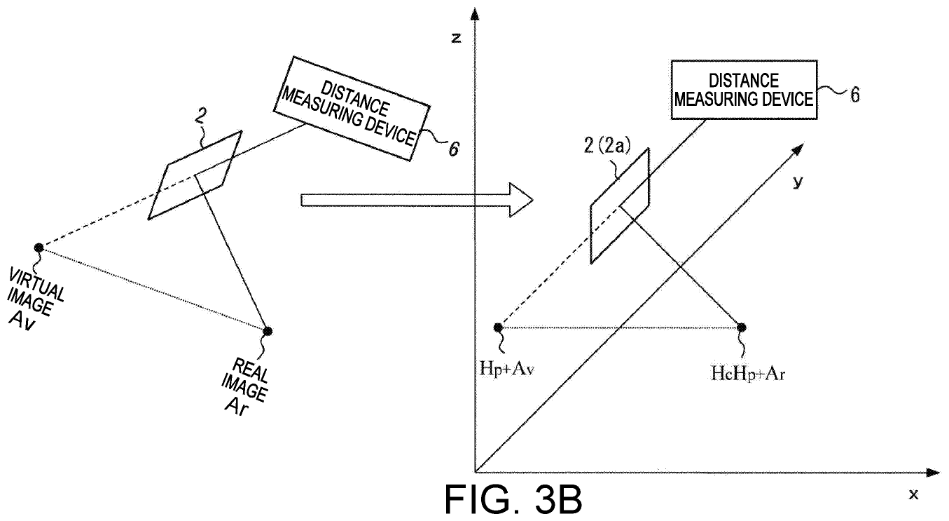

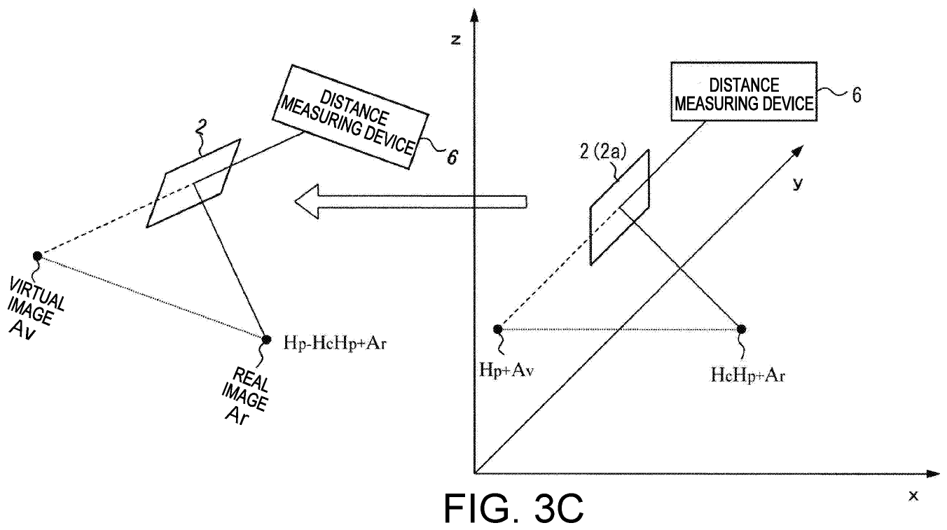

Next, with reference to FIGS. 3A, 3B, and 3C, a reflection conversion method when the mirror 2a is installed at predetermined coordinates is described. FIG. 3A illustrates an example in which the mirror 2a is installed at a predetermined coordinate position. That is, the mirror 2a in FIG. 3A can be non-parallel to the yz-plane, the xz-plane, and the xy-plane. In this case, the coordinates of the virtual image are represented by the matrix Av as described above. First, as illustrated in FIG. 3B, the mirror 2a is moved by the transformation matrix Hp+ such that the coordinates of the mirror 2a are in the yz-plane. Since the mirror 2a is in the yz-plane, the reflection conversion is performed using the reflection conversion matrix Hc expressed in Equation (2). Next, as illustrated in FIG. 3C, to return to the original coordinate system, the coordinate system is converted with the conversion matrix Hp− to restore the original coordinate system. A series of processing is expressed by Equation (4):

Aᵣ=Hₚ₋H_{c}Hₚ₊Aᵥ (4)

Thus, the mirror 2a disposed at a predetermined position can be moved to the yz-plane by translation and rotation. The conversion matrix P of the translation Tx, Ty, and Tz in the directions of the x-axis, the y-axis, and the z-axis, respectively, is expressed by Equation (5):

$$P ( {T}_{x} , {T}_{y} , {T}_{z} ) = ( \begin{matrix}1 & 0 & 0 & {T}_{x} \\ 0 & 1 & 0 & {T}_{y} \\ 0 & 0 & 1 & {T}_{z} \\ 0 & 0 & 0 & 1\end{matrix} ) \qquad ( 5 )$$

Further, the conversion matrices Rx(θ), Ry(θ), and Rz(θ) for rotating θ times around the x-axis, the y-axis, and the z-axis, respectively, are represented by Equations (6) to (8).

$$\begin{matrix}{R}_{x} ( θ ) = ( \begin{matrix}1 & 0 & 0 & 0 \\ 0 & cos θ & - sin θ & 0 \\ 0 & sin θ & cos θ & 0 \\ 0 & 0 & 0 & 1\end{matrix} ) & ( 6 ) \\ {R}_{y} ( θ ) = ( \begin{matrix}cos θ & 0 & sin θ & 0 \\ 0 & 1 & 0 & 0 \\ - sin θ & 0 & cos θ & 0 \\ 0 & 0 & 0 & 1\end{matrix} ) & ( 7 ) \\ {R}_{z} ( θ ) = ( \begin{matrix}cos θ & - sin θ & 0 & 0 \\ sin θ & cos θ & 0 & 0 \\ 0 & 0 & 1 & 0 \\ 0 & 0 & 0 & 1\end{matrix} ) & ( 8 )\end{matrix}$$

In a case where, for example, the translation a0 in the x-axis direction, the rotation of θ0 time on the y-axis, and the rotation of el time on the z-axis, the conversion matrix Hp+ of Equation (4) is expressed as Equation (9):

Hₚ₊=R_{z}(θ₁)R_{y}(θ₀)Pₓ(a₀) (9)

The transformation matrix Hp− in Equation (4) only restores the coordinate system transformed by Hp+ in Equation (9) to the original coordinate system, and becomes the inverse matrix of the transformation matrix Hp+ as illustrated in Equation (10):

Hₚ₋=(Hₚ₊)⁻¹ (10)

As described above, the reflection conversion method in the case where the mirror 2a exists at the predetermined position can be processed by the inner product calculation of the matrix expressed by Equation (4). The inner product calculation requires a multiplication processing, which increases the calculation cost.

Next, assuming that the movement of the mirror 2a to the yz-plane can be realized only by the translation, the translation matrix is expressed by Equation (11). Equation (11) is the conversion matrix Pm when the translation Tx, Ty, and Tz are performed in the directions of the x-axis, y-axis, and z-axis directions, respectively:

$${P}_{m} = ( \begin{matrix}{T}_{x} \\ {T}_{y} \\ {T}_{z} \\ 1\end{matrix} ) \qquad ( 11 )$$

Thus, the coordinate conversion matrix Ar when the movement of the mirror 2a to the yz-plane can be achieved only by the translation, the coordinate conversion matrix Ar is expressed by Equation (12):

Aᵣ=H_{c}(Aᵥ+Pₘ)−Pₘ (12)

Here, when moving the mirror 2a to the yz-plane, it is not necessary to move in the y-axis and z-axis directions, and Ty=Tz=0 in Equation (11). Further, assuming that the position of the mirror 2a is in the yz-plane, the reflection conversion matrix Hc is equivalent to the inversion of the sign of the x-coordinate, and is therefore expressed by Equation (13):

$${A}_{r} = ( \begin{matrix}- ( {x}_{0} + {T}_{x} ) - {T}_{x} \\ {y}_{0} \\ {z}_{0} \\ 1\end{matrix} ) = ( \begin{matrix}- {x}_{0} - 2 {T}_{x} \\ {y}_{0} \\ {z}_{0} \\ 1\end{matrix} ) \qquad ( 13 )$$

Further, only the translation processing is performed and there is no need to increase the number of dimensions, so that Equations (11) and (13) can be replaced with Equations (14) and (15), respectively.

$$\begin{matrix}{P}_{m} = ( \begin{matrix}{T}_{x} \\ {T}_{y} \\ {T}_{z}\end{matrix} ) & ( 14 ) \\ {A}_{r} = ( \begin{matrix}- {x}_{0} - 2 {T}_{x} \\ {y}_{0} \\ {z}_{0}\end{matrix} ) & ( 15 )\end{matrix}$$

Therefore, if the movement of the mirror 2a can be achieved only by the translation, the multiplication processing is unnecessary to convert the coordinates of the virtual image. That is, the calculation amount can be reduced largely by disposing the reflector 2 in parallel to the yz-plane in FIG. 3A.

In the above example, the mirror 2a is disposed so that the reflector 2 is parallel to the yz-plane. Similarly, the same effect can be obtained by disposing the mirror 2a in parallel to the zx-plane or the xy-plane. In summary, the coordinate conversion processing of the virtual image when the mirror 2a is disposed in parallel to the yz-, zx-, and xy-planes is given by Equations (16) to (18), respectively:

$$\begin{matrix}{A}_{r} = ( \begin{matrix}- {x}_{0} - 2 {T}_{x} \\ {y}_{0} \\ {z}_{0}\end{matrix} ) & ( 16 ) \\ {A}_{r} = ( \begin{matrix}{x}_{0} \\ - {y}_{0} - 2 {T}_{y} \\ {z}_{0}\end{matrix} ) & ( 17 ) \\ {A}_{r} = ( \begin{matrix}{x}_{0} \\ {y}_{0} \\ - {z}_{0} - 2 {T}_{z}\end{matrix} ) & ( 18 )\end{matrix}$$

Although one mirror 2a has been described above, the same applies to the case where there is a plurality of mirrors 2a. More specifically, by disposing at least one of the plurality of mirrors 2a on any of the yz-plane, the zx-plane, or the xy-plane, the coordinate conversion of the virtual image can be performed without multiplication processing.

As described above, by disposing the mirror 2a substantially parallel to the yz-plane, the zx-plane, or the xy-lane, it is possible to reduce the amount of the calculation processing of the coordinate conversion processing in converting the virtual image into the real image. On the other hand, if the mirror 2a is not disposed substantially parallel to the yz-plane, the zx-plane, or the xy-plane, the adjustment is necessary to at least one of the mirror 2a or the distance measuring device 6. For example, an actuator capable of adjusting at least one of the position or angle of the mirror 2a may be provided, and an adjusting function of automatically adjusting the mirror 2a to be substantially parallel to the yz-plane, the zx-plane, or the xy-plane may be provided. Alternatively, a function of automatically adjusting the position and the inclination angle of the support table on which the distance measuring device 6 is disposed may be provided. Alternatively, the mirror 2a and the distance measuring device 6 may be adjusted manually. In adjusting automatically or manually, high-precision adjustment is available if the system 1 outputs an adjustment signal that represents in what direction and to what extent the mirror 2a and the distance measuring device 6 are moved.

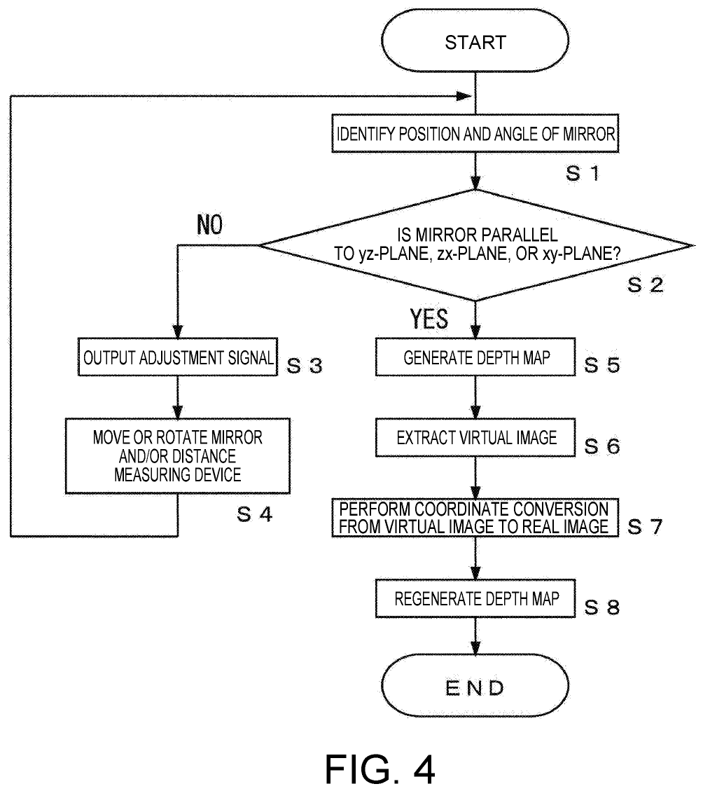

FIG. 4 is a flowchart illustrating the processing operation of the system 1 according to the present embodiment. The flowchart of FIG. 4 starts when the power of the system 1 is turned on, and processing of generating the depth map of the object is performed.

First, the position and angle of the mirror 2a are specified (step S1). The position and angle of the mirror 2a may be specified in accordance with the image taken by the imaging device, or may be specified from the points of the depth map generated by the distance measuring device 6. Alternatively, the laser may be used to receive the radio wave reflected by the mirror 2a and specify the position and angle of the mirror 2a.

Next, it is determined whether the mirror 2a is parallel to the yz-plane, the zx-plane, or the xy-plane (step S1). Since the system 1 has recognized the coordinate system of the distance measuring device 6 in advance, by comparing the position and angle of the mirror 2a specified in step S1 with the coordinate system of the distance measuring device 6, it is determined whether the mirror 2a is parallel to the yz-plane, the zx-plane, or the xy-plane. Instead of detecting the position and angle of the mirror 2a from the image captured by the imaging device, the position and angle of the mirror 2a may be detected from the points of the depth map generated by the distance measuring device 6, and the detected position and angle of the mirror 2a may be compared with the coordinate system of the distance measuring device 6.

If no parallelism is determined in step S2, the adjustment signal indicating in what direction and to what extent at least one of the mirror 2a or the distance measuring device 6 needs to be moved or rotated is generated and output (step S3). The adjustment signal is generated, for example, by the distance measuring device 6.

In a case where the adjusting mechanism for automatically adjusting at least one of the mirror 2a or the distance measuring device 6 is provided, the adjusting mechanism moves or rotates at least one of the mirror 2a and the distance measuring device 6 in accordance with the adjustment signal (step S4). On the other hand, if the adjusting mechanism is not provided, the user of the present system 1 manually moves or rotates at least one of the mirror 2a or the distance measuring device 6 in accordance with the adjustment signal (step S4).

Once the adjustment in step S4 is completed, the processing is repeated from step S1. If the parallelism is determined in step S2, the depth map is generated in the distance measuring device 6 (step S5). Next, the extraction unit 9 extracts the virtual image from the depth map (step S6). Since the position and angle of the mirror 2a are already known in the process of step S1, the time required for the light emitted from the light emitting unit 3 to be reflected by the mirror 2a and received by the light receiving unit 4 can be known in advance. If, therefore, the light is received by the light receiving unit 4 after the time longer than expected, the extraction unit 9 can recognize that the light is from the virtual image.

Next, the coordinate conversion processing from the virtual image to the real image is performed in accordance with, for example, Equation (10) (step S7). Then, the depth map in which the virtual image is converted into the real image is generated (step S8).

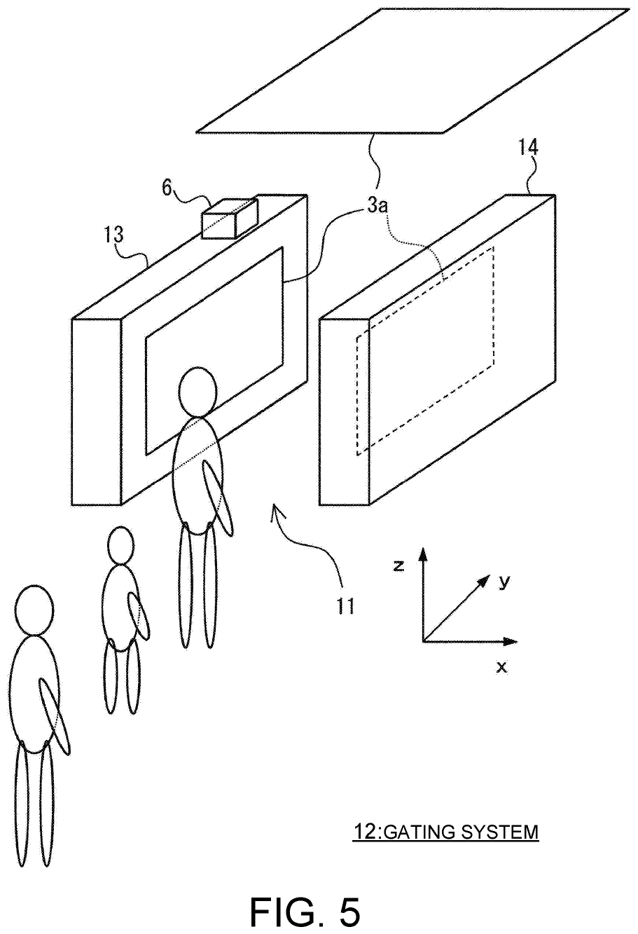

FIG. 5 illustrates an example in which the system 1 according to the present embodiment is applied to a gating system 12 that controls passage of a gate 11. The gating system 12 of FIG. 5 counts the number of people who pass through the gate 11. In the gating system 12 of FIG. 5, a person travels along a traffic route between two gate stands 13 and 14 disposed on both sides of the traffic route. The mirror 2a is attached to the inner wall surface of each of the gate stands 13 and 14, and the mirror 2a is also installed above the traffic route. The distance measuring device 6 is placed on the upper surfaces of the gate stands 13 and 14.

In the distance measuring device 6 of the gating system 12 of FIG. 5, for example, a direction in which the gate stands 13 and 14 are disposed in the x-direction, a passing direction of the gate 11 is in the y-direction, and a direction normal to the installation surface of the gate stands 13 and 14 is in the z-direction. Therefore, the mirrors 2a attached to the inner wall surfaces of the gate stands 13 and 14 are disposed substantially parallel to the zx-plane, and the mirrors 2a installed above the traffic path are disposed substantially parallel to the xy-plane. Therefore, all mirrors 2a are substantially parallel to the zx-plane or the xy-plane, so that the coordinate conversion processing from the virtual image to the real image can be performed only by translation, and the virtual image in the depth map can be converted easily and quickly into the real image.

As illustrated in FIG. 5, by arranging the mirror 2a on the inner wall surfaces of the two gate stands 13 and 14 disposed on both sides of the traffic route, and by disposing the mirror 2a above the traffic route as well, there is no risk of missing the traffic of the child even when a child is surrounded by adult persons and passes through the gate 11. Further, with the installation location of the distance measuring device 6 as a reference, by disposing the mirror 2a substantially parallel to the zx-plane and disposing the mirror 2a substantially parallel to the xy-plane, the amount of calculation processing in performing the coordinate conversion from the virtual image to the real image can be reduced.

The gating system 12 of FIG. 5 is merely one specific application example of the system 1 according to the present embodiment. The system 1 according to the present embodiment can be widely applied to the system 1 including a process of converting a virtual image into a real image.

In the above-described embodiment, the example in which the distance to the object is measured by the ToF method using the light emitting unit 3 and the light receiving unit 4 has been described, but the present embodiment is also applicable to the case where a stereo camera is used. The stereo camera can measure the distance to the subject using the parallax between the images captured by the left-eye camera and the right-eye camera.

As described above, in the present embodiment, the reflector 2 is disposed substantially parallel to the yz-plane, the zx-plane, or the xy-plane of the coordinate system of the distance measuring device 6, the virtual image position in the depth map is coordinate-converted into the real image position, it is possible to reduce the calculation processing amount when performing the processing. More specifically, since the virtual image can be converted into the real image only by the coordinate conversion processing of only the translation, the multiplication processing becomes unnecessary, and the depth map including the real image can be quickly generated from the depth map including the virtual image.

1. A method using an electronic apparatus capable of measuring a distance from the electronic apparatus, comprising:
acquiring information on at least one of a position or shape of an object in accordance with a reflected light reflected by both the object and a reflector,
wherein the reflector is disposed substantially parallel to one of a first plane, a second plane, and a third plane that defines a coordinate system of the electronic apparatus to measure the distance.

2. The method of claim 1, further comprising:
deriving the information on at least one of the position or shape of the object based on the reflected light on the basis of a fact that the reflector is disposed substantially parallel to one of the first plane, the second plane, and the third plane.

3. The method of claim 1, wherein
the electronic device includes a light emitter configured to emit light having a light emitting direction in the coordinate system as an optical axis center, and a light receiver configured to receive the incident light, and
the incident light includes at least light received by the light receiver after being emitted from the light emitter and reflected by the reflector, the object, and the reflector.

4. The method of claim 3, wherein
the light emitter intermittently emits the light having the light emitting direction in the coordinate system as the optical axis center, and
the light receiver receives light from a light receiving direction in the coordinate system.

5. The method of claim 3, further comprising:
measuring a distance to the object from a time difference between timing at which the light emitter emits light and timing at which the emitted light reflected by the object is received by the light receiver; and
acquiring the information in accordance with the measured distance.

6. The method of claim 5, wherein
a depth map is generated in accordance with the measured distance to the object,
a virtual image included in the depth map is extracted, and
a position of the extracted virtual image is converted into a position of a real image in accordance with a position of the reflector.

7. The method of claim 6, further comprising:
converting the position of the extracted virtual image into the position of the real image by coordinate conversion by translation instead of coordinate conversion by rotation.

8. The method of claim 1, further comprising:
disposing, when a plurality of the reflectors is provided, at least one of the reflectors to be substantially parallel to the first plane, the second plane, or the third plane.

9. The method of claim 1, further comprising:
acquiring reflector information including at least one of a position, size, height, or an angle of the reflector.

10. The method of claim 9, further comprising:
detecting the reflector information in accordance with the incident light.

11. The method of claim 9, further comprising:
detecting the reflector information in accordance with an image photographed by an imager.

12. The method of claim 9, further comprising:
determining, in accordance with the reflector information, whether the reflector is substantially parallel to the first plane, the second plane, or the third plane.

13. The method of claim 12, further comprising:
outputting, when it is determined that the reflector is substantially non-parallel to the first plane, the second plane, and the third plane, an adjustment signal for disposing the reflector substantially parallel to the first plane, the second plane, or the third plane.

14. The method of claim 12, further comprising:
performing, when it is determined that the reflector is substantially non-parallel to the first plane, the second plane, and the third plane, adjustment to dispose the reflector substantially parallel to the first plane, the second plane, or the third plane.

15. The method of claim 1, further comprising:
disposing, when an acquisitor configured to acquire information on at least one of the position or shape of the object is disposed on a support table parallel to the first plane, a first reflector above the acquisitor and substantially parallel to the first plane; and
disposing at least one second reflector in a direction orthogonal to the first reflector.

16. The method of claim 15, further comprising:
disposing a plurality of the second reflectors on both sides of a passage of a gate that controls passage in a direction substantially parallel to the second plane or the third plane, along the passage.

17. A system using an electronic device capable of measuring a distance from the electronic apparatus, the system comprising:
processing circuitry configured to acquire information on at least one of the position or shape of the object in accordance with reflected light reflected by both the object and a reflector,
wherein the reflector is disposed substantially parallel to one of a first plane, a second plane, and a third plane that are orthogonal to each other and define a coordinate system for measuring a distance of the electronic device.

18. The system of claim 17, further comprising:
a light emitter that emits light having a light emitting direction in the coordinate system as an optical axis center;
a light receiver that receives the incident light,
wherein the processing circuitry is further configured to:
determinate whether the reflector is substantially parallel to the first plane, the second plane, or the third plane in accordance with reflector information including at least one of a position, size, height, and an angle of the reflector;
output an adjustment signal for disposing the reflector to be substantially parallel to the first plane, the second plane, or the third plane, when it is determined that the reflector is substantially non-parallel to the first plane, the second plane, or the third plane;
measure a distance to the object, when it is determined that the reflector is substantially parallel to the first plane, the second plane, or the third plane, from a time difference between timing at which the light emitter emits light and timing at which the emitted light reflected by the object is received by the light receiver, and generates a depth map in accordance with the measured distance to the object;
extract a virtual image included in the depth map; and
convert a position of the extracted virtual image to a position of a real image in accordance with a position of the reflector.
